(19) United States
(12) Patent Application Publication
(10) Pub. No.: US 2015/0090077 A1
(43) Pub. Date: Apr. 2, 2015

(54) HAND TOOL CAPABLE OF INDICATING REVOLUTION NUMBER

(71) Applicant: Chin-Tan HUANG, Taichung City (TW)

(72) Inventor: Chin-Tan HUANG, Taichung City (TW)

(21) Appl. No.: 14/150,733

(22) Filed: Jan. 8, 2014

(30) Foreign Application Priority Data
Oct. 1, 2013 (TW) 102218352

(51) Int. Cl. B25B 23/142

(52) U.S. Cl. CPC B25B 23/1422
USPC 81/429

(57) ABSTRACT

A hand tool includes a central shaft extending along an axis and having a threaded section, a tool head sleeved rotatably on the central shaft, a pressing block sleeved movably on the central shaft, an adjusting member threaded to the threaded section of the central shaft and rotatable to move the pressing block on the central shaft, and an indication unit. The indication unit includes a slide slot formed in a handle, an indicating member disposed movably on the handle and having a guiding projection movable within the slide slot, and a revolution number scale disposed on the handle and adjacent to the slide slot. The indicating member is connected to and co-movable with the adjusting member.

### CROSS-REFERENCE TO RELATED APPLICATION

This application claims priority of Taiwanese Application No. 102218352, filed on Oct. 1, 2013.

### BACKGROUND OF THE INVENTION

1. Field of the Invention

This invention relates to a hand tool, and more particularly to a hand tool capable of indicating revolution number.

2. Description of the Related Art

Referring to FIGS. 1 and 2, a conventional torque adjusting device 10 disclosed in Taiwanese Patent NO. M395550 by the applicant includes a main shaft unit 11, a braking unit 15, a compression spring 16, an adjustment unit 17, a positioning unit 18, and an indicating unit 19.

The main shaft unit 11 includes first and second tool heads 12, 13 rotatable about an axis (I), and a connecting mechanism 14 interconnecting the first and second tool heads 12, 13 in such a manner to allow for relative rotation therebetween. The first tool head 12 includes a connecting rod 121, an accommodating member 123 having a diameter greater than that of the connecting rod 121 and formed with an accommodating chamber 122, an internal toothed ring 124 disposed fixedly within the accommodating member 123, and an axial hole 125 extending through the connecting rod 121 and in spatial communication with the accommodating chamber 122. The second tool head 13 extends into the first tool head 12 along the axis (I), and includes a rod body 131 disposed in the accommodating member 123, a threaded portion 132 disposed outwardly of the accommodating member 123, and a tool head rod 133. The threaded portion 132 has a non-circular section 134.

The connecting mechanism 14 includes an annular groove 141 disposed in the connecting rod 131, and a C-shaped retaining ring 142 received within the annular groove 141.

The braking unit 15 includes a supporting member 151 sleeved fixedly on the rod body 131 and adjacent to the internal toothed ring 124, a plurality of balls 153, and a pushing block 154. The supporting member 151 is disposed in the accommodating chamber 122, and has a plurality of open-ended radial slots 152 for receiving respectively the balls 153. The pushing block 154 is sleeved on the rod body 131, and is pressed against the balls 153.

The compression spring 16 is sleeved on the second tool head 13 for biasing the pushing block 154.

The adjustment unit 17 includes a pressing plate 171 sleeved on the threaded portion 132 and abutting against the compression spring 16, an adjustment nut 172 engaging the threaded portion 132, and a rotary knob 173 sleeved on the adjustment nut 172.

The positioning unit 18 includes an inner retaining ring 181 received within an annular groove in the adjustment nut 172, an anti-rotation ring 182 having a hole permitting the non-circular section 134 to be fitted therein, an outer retaining ring 183 received within an annular groove in the non-circular section 134 for retaining the outer retaining ring 183 on the non-circular section 134, and a controlling member 184 having an internally splined surface engaging externally splined surfaces of the adjustment nut 172 and the anti-rotation ring 182. Due to the presence of the positioning unit 18, the adjustment nut 172 can be converted between a rotatable state and a non-rotatable state.

The indicating unit 19 includes a torque scale 191 disposed on the rotary knob 173, and a pointer 192 disposed on the controlling member 184 and cooperating with the torque scale 191 to indicate a torque value.

During use, the rotary knob 173 can be operated to move the adjustment nut 172 along the axis, so as to change the position of the pressing plate 171 and, thus, the compressed amount of the compression spring 16. Hence, the axial pushing force of the compression spring 16 applied to the pushing block 154 and the radial braking force of the balls 153 applied to the tool head 12 are changed. In this manner, the torque of the tool head 12 can be adjusted.

However, the conventional torque adjusting device 10 has a drawback. That is, when the revolution number of the rotary knob 173 exceeds one, it cannot be realized.

### SUMMARY OF THE INVENTION

The object of this invention is to provide a hand tool that includes an improved toque adjusting device capable of indicating the revolution number of an adjusting member to result in convenience during use of the hand tool.

According to this invention, a hand tool includes a central shaft extending along an axis and having a threaded section, a tool head sleeved rotatably on the central shaft, a pressing block sleeved movably on the central shaft, an adjusting member threaded to the threaded section of the central shaft and rotatable to move the pressing block on the central shaft, and an indication unit. The indication unit includes a slide slot formed in a handle, an indicating member disposed movably on the handle and having a guiding projection movable within the slide slot, and a revolution number scale disposed on the handle and adjacent to the slide slot. The indicating member is connected to and co-movable with the adjusting member.

### BRIEF DESCRIPTION OF THE DRAWINGS

These and other features and advantages of this invention will become apparent in the following detailed description of a preferred embodiment of this invention, with reference to the accompanying drawings, in which:

FIG. 1 is an exploded perspective view of a conventional torque adjusting device disclosed in Taiwanese Patent No. M395550;

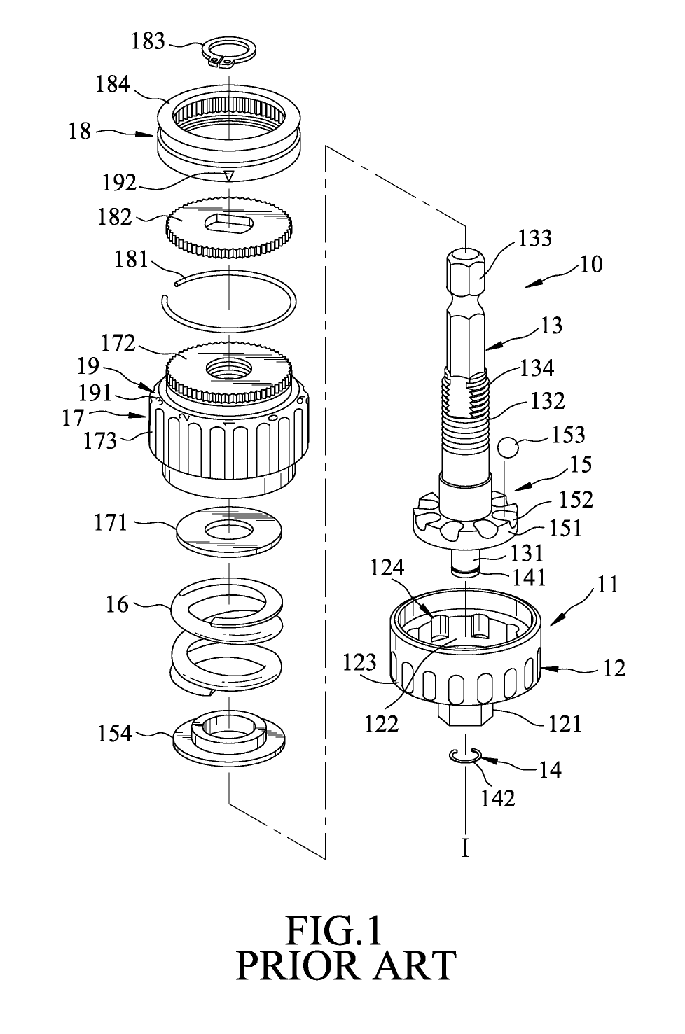

FIG. 2 is a sectional view of a hand tool including the conventional torque adjusting device;

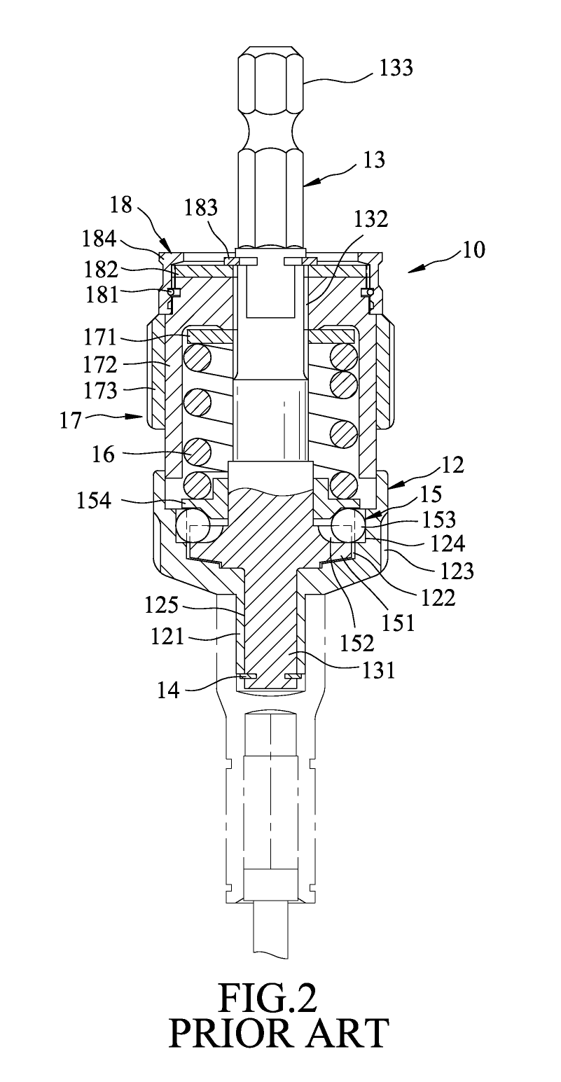

FIG. 3 is an exploded perspective view of a torque adjusting device of the preferred embodiment of a hand tool according to this invention;

FIG. 4 is a fragmentary exploded perspective view of the preferred embodiment, illustrating an anti-rotation mechanism;

FIG. 5 is a fragmentary exploded perspective view of the preferred embodiment, illustrating a locking unit;

FIG. 6 is a top view of the preferred embodiment, illustrating a revolution number scale and a torque scale;

FIG. 7 is a fragmentary sectional view of the preferred embodiment;

FIG. 8 is a sectional view taken along line VIII-VIII in FIG. 7, illustrating that a tool head is in a rotatable state;

FIG. 9 is a view similar to FIG. 8 but illustrating that the tool head is in a non-rotatable state;

FIG. 10 is a view similar to FIG. 7 but illustrating a rotary knob is in a released state;

FIG. 11 is a view similar to FIG. 7 but illustrating that the torque of the tool head is adjusted; and

FIG. 12 is a view similar to FIG. 6 but illustrating that the revolution number of the rotary knob and the torque value of the tool head are changed.

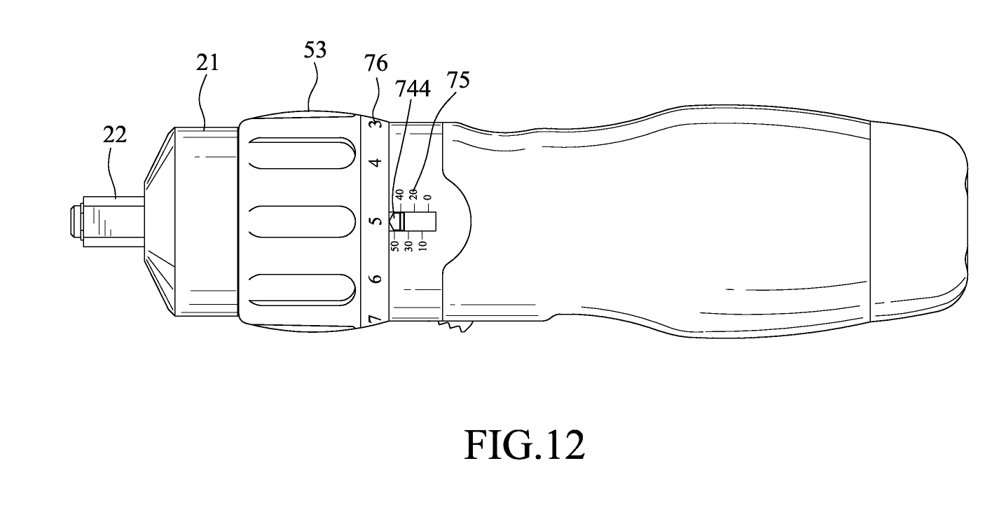

### DETAILED DESCRIPTION OF THE PREFERRED EMBODIMENT

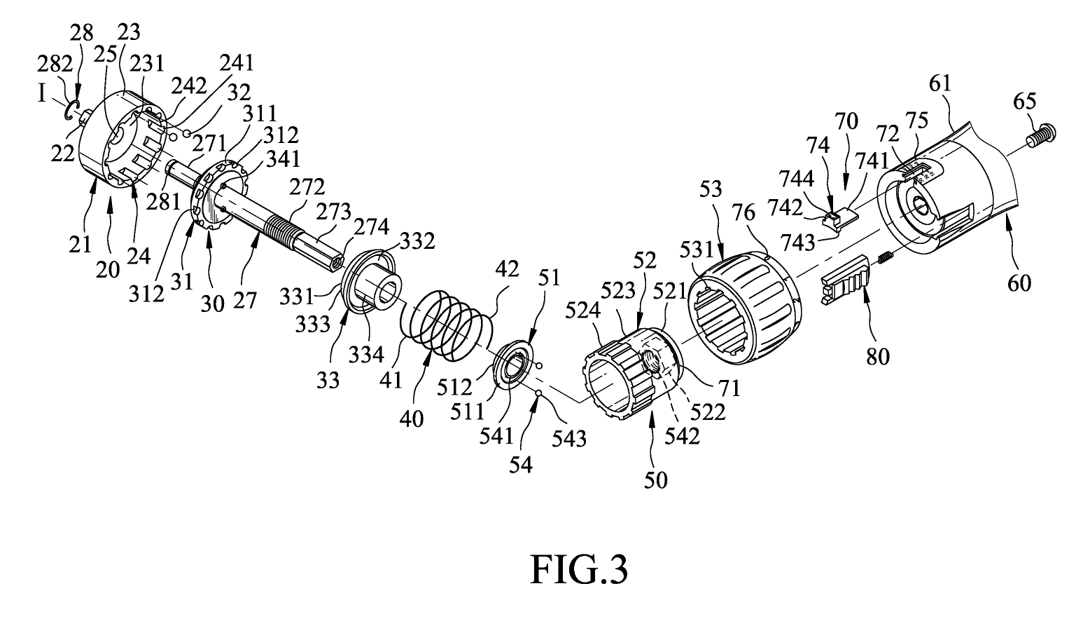

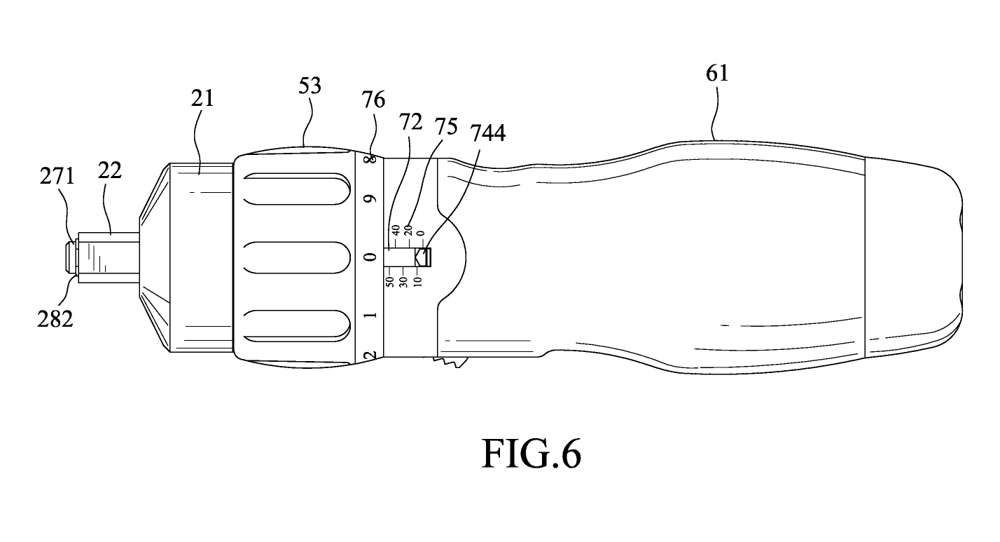

Referring to FIGS. 3, 6, and 7, the preferred embodiment of a hand tool according to this invention includes a main shaft unit 20, a braking unit 30, a first resilient member 40, an adjustment unit 50, a handle unit 60, an indication unit 70, and a locking unit 80.

The main shaft unit 20 includes a tool head 21 and a central shaft 27 that are rotatable about an axis (I). In other words, the central shaft 27 extends along the axis (I). The main shaft unit 20 further includes a connecting mechanism 28.

The tool head 21 is sleeved rotatably on a front end of the central shaft 27, and includes: a connecting rod 22 extending along the axis (I); an accommodating member 23 connected integrally to and disposed behind the connecting rod 22 and having a diameter greater than that of the connecting rod 22, and formed with an accommodating chamber 231; an internal toothed ring 24 connected integrally to and disposed behind the accommodating member 23 and defining the accommodating chamber 231; and an axial hole 25 extending through the connecting rod 22 along the axis (I) and in spatial communication with the accommodating chamber 231.

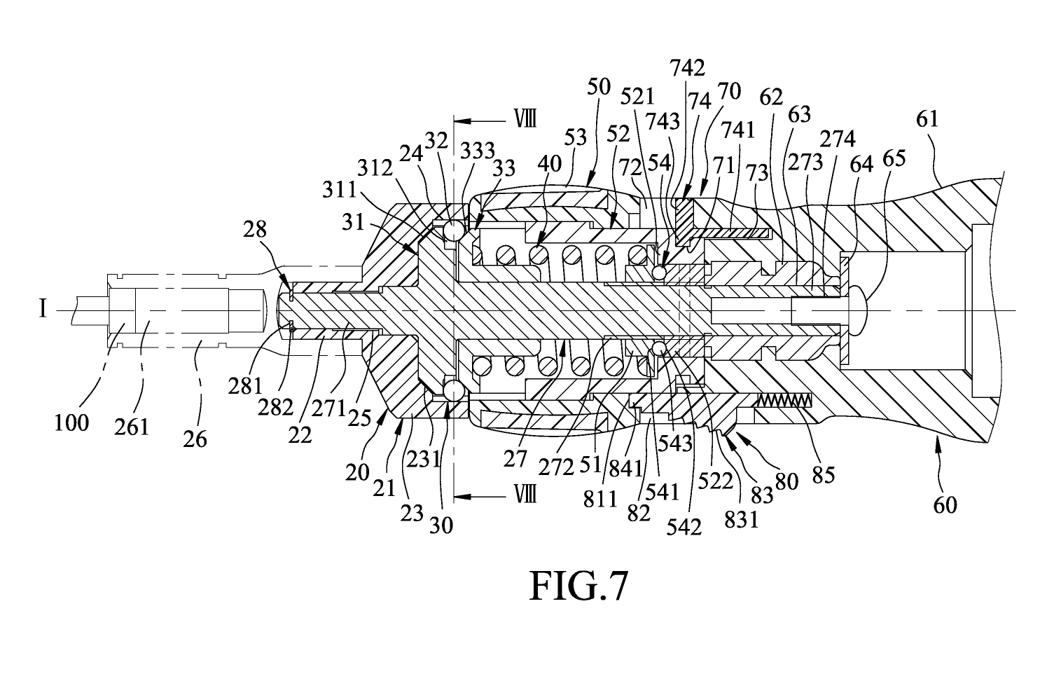

In this embodiment, the connecting rod 22 has a polygonal cross-section, and can be inserted into a polygonal hole in a fastener (not shown). If necessary, the connecting rod 22 may be connected with a fastener 100 (see FIG. 7) by a connecting piece 26. The connecting piece 26 has two polygonal holes 261 engaging respectively the fastener 100 and the connecting rod 22.

The internal toothed ring 24 has an inner surface that includes a plurality of curved concave portions 241, and a plurality of curved convex portions 242 arranged alternately with the concave portions 241.

The central shaft 27 has a circular rod section 271 disposed in the accommodating member 23, a threaded section 272 disposed outwardly of the accommodating member 23, a polygonal rod section 273, and a threaded hole 274 extending along the axis (I) and formed in the polygonal rod section 273.

The connecting mechanism 28 includes an annular groove 281 formed in the circular rod section 271, and a C-shaped retaining ring 282 received within the annular groove 281, so as to connect the tool head 21 rotatably to the central shaft 27.

The braking unit 30 includes a supporting member 31, a plurality of braking members 32, a pushing block 33, and an anti-rotation mechanism 34.

The supporting member 31 is sleeved fixedly on the circular rod section 271 of the central shaft 27, is disposed within the accommodating chamber 231, and is adjacent to the internal toothed ring 24. In this embodiment, the supporting member 31 has a main body 311, and a plurality of radial accommodating grooves 312 each having an open outer end formed in an annular outer surface of the main body 311, and a closed inner end defining by a flat surface. The accommodating grooves 312 receive respectively the braking members 32. The braking members 32 are confined among the internal toothed ring 231, the supporting member 31, and the pushing block 33.

In this embodiment, the braking members 32 are configured as balls.

The pushing block 33 is sleeved movably on the circular rod section 271 of the central shaft 27, and has a pressing surface 331 facing the supporting member 31, a pushed surface 332 facing away from the supporting member 31 and having an outer diameter greater than that of the pressing surface 331, a frustoconical surface 333 connected between the pressing surface 331 and the pushed surface 332, and a first annular flange 334 extending from the pushed surface 332.

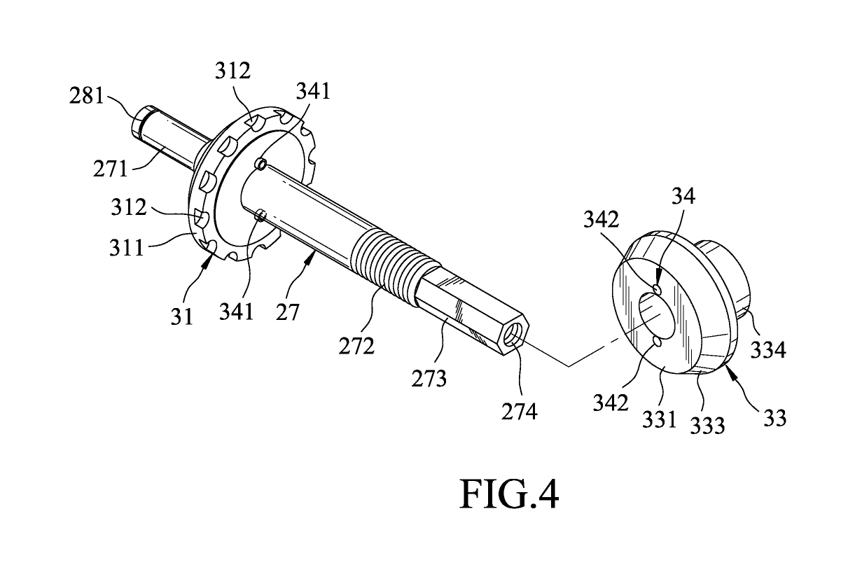

With particular reference to FIGS. 3 and 4, the anti-rotation mechanism 34 is disposed between the supporting member 31 and the pushing block 33 for preventing relative rotation therebetween. The anti-rotation mechanism 34 includes two stubs 341 extending from the supporting member 31 and parallel to the axis (I), and two grooves 342 formed in the pressing surface 331 of the pushing block 33 and engaging respectively the stubs 341. In an alternative arrangement, the stubs 341 extend from the pushing block 33, and the grooves 342 are formed in the supporting member 31. Or, the anti-rotation mechanism 34 may include only one stub 341 and only one groove 342.

In this embodiment, the first resilient member 40 is configured as a coiled compression spring sleeved around the central shaft 27, and has a first end 41 sleeved around the first annular flange 334 and abutting against the pushed surface 332, and a second end 42 opposite to the first end 41.

The adjustment unit 50 includes a pressing block 51 sleeved on the threaded section 272 of the central shaft 27, an adjusting member 52 sleeved on and threaded to the threaded section 272 of the central shaft 271, a rotary knob 53 sleeved on and co-rotatable with the adjusting member 52 and allowing for manual operation, and a connecting mechanism 54.

The pressing block 51 includes a ring plate 511 abutting against the second end 42 of the first resilient member 40, and a second annular flange 512 extending from the ring plate 511 and permitting the second end 42 of the first resilient member 40 to be sleeved thereon.

The adjusting member 52 includes an annular connecting wall 521, a nut 522 fixed within the connecting wall 521 and engaging the threaded section 272 of the central shaft 27, and a surrounding wall 523 extending forwardly from the connecting wall 521, surrounding the axis (I), and having a splined outer surface 524.

The rotary knob 53 has a splined inner surface 531 that engages the splined outer surface 524 so as to allow for movement of the adjusting member 52 relative to the rotary knob 53, while preventing rotation of the adjusting member 52 relative to the rotary knob 53. The connecting wall 521 of the adjusting member 52 is disposed outwardly of the rotary knob 53.

The connecting mechanism 54 includes a first annular groove 541 formed in the ring plate 511 of the pressing block 51, a second annular groove 542 formed in the nut 522, and a plurality of balls 543 engaging the first and second annular grooves 541, 542. As such, rotation and movement of the adjusting member 52 result in only rotation of the pressing block 51.

Alternatively, the nut 522 may be omitted from the adjusting member 52. In this case, a threaded hole and the second annular groove 542 may be formed directly in the connecting wall 521.

The handle unit 60 includes a handle 61 sleeved fixedly on the central shaft 27, a locking block 62 fixed within the handle 61, a polygonal hole 63 formed in the locking block 62 and permitting the polygonal rod section 273 of the central shaft 27 to be engaged fittingly therein, a washer 64 abutting against an end of the locking block 62, and a lock bolt 65 extending through the washer 64 to engage the threaded hole 274 in the central shaft 27 so as to lock the central shaft 27 relative to the locking block 62.

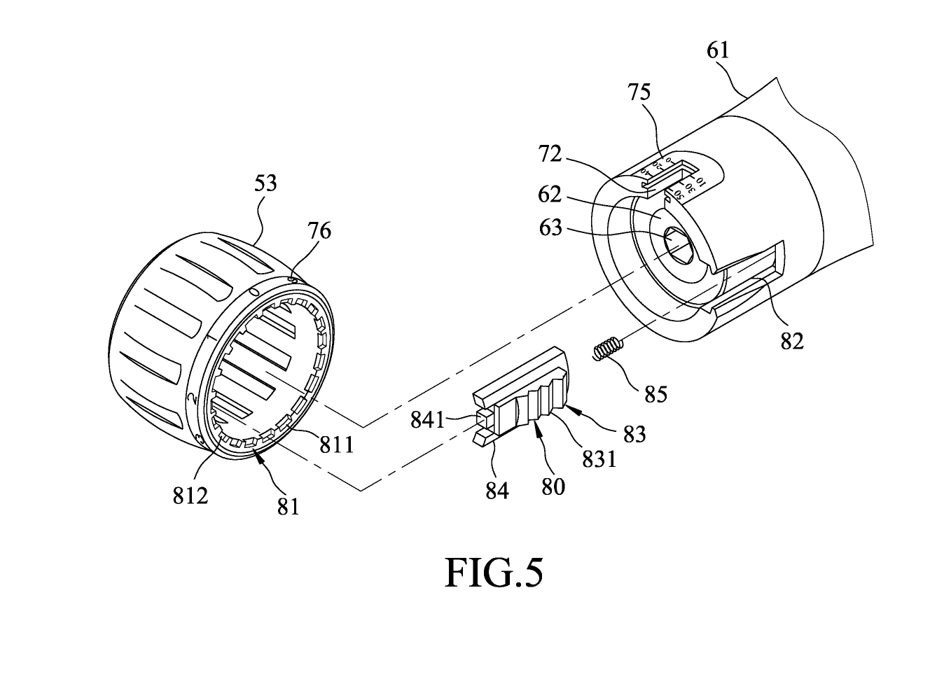

With particular reference to FIGS. 3, 5, 6, and 7, the indication unit 70 includes an annular groove 71 formed in the connecting wall 521 of the adjusting member 52, a slide slot 72 formed in a front end of the handle 61 and parallel to the axis (I), an insert groove 73 formed in the locking block 62 along a direction parallel to the axis (I) and in spatial communication with the slide slot 72, an indicating member 74 inserted into the insert groove 73 and movable in the slide slot 72, a revolution number scale 75 disposed on the handle 61 and adjacent to the slide slot 72, and a torque scale 76 disposed on an annular outer surface of the rotary knob 53 and adjacent to the annular groove 71 in the adjusting member 52.

The indicating member 74 has an insert plate portion 741 inserted movably into the insert groove 73, a guiding projection 742 extending upwardly from a top side surface of the insert plate portion 741 and disposed movably within the slide slot 72, and a connecting projection 743 extending downwardly from a bottom side surface of the insert plate portion 741 and engaging movably the annular groove 71 in the adjusting member 52. The guiding projection 742 is formed with a pointer 744. Through cooperation of the pointer 744 and the revolution number scale 75, the revolution number of the adjusting member 52 can be realized. The revolution number of the adjusting member 52 is proportional to both the compressed amount of the first resilient member 40 and the torque value of the tool head 21. Through cooperation of the pointer 744 and the torque scale 74, the torque value can be realized.

The locking unit 80 includes: a toothed flange 81 extending radially and inwardly from a rear end of the rotary knob 53 and having a plurality of angularly equidistant teeth 811, any two adjacent ones of the teeth 811 defining a keyway 812; a block-receiving slot 82 formed in a front end of the handle 61, having an open front end, and parallel to the axis (I); an operating block 83 inserted movably into the block-receiving slot 82 and having a toothed front end 84; and a second resilient member 85 disposed in the handle 61 for biasing the operating block 83.

The operating block 83 has a serrated finger-touching side portion 831 consisting of a plurality of triangular teeth each having a tooth peak which is closer to the axis (I) than that of an adjacent one of the triangular teeth disposed therebehind, so that the user ca push easily and conveniently the operating block 83.

The toothed front end 84 of the operating block 83 has three key teeth 841 engaging respectively and removably three selected keyways 812, so as to prevent rotation of the rotary knob 53 relative to the handle 61. The operating block 83 is movable manually within the block-receiving slot 82 to remove the key teeth 841 from the three selected keyways 812, so as to allow for rotation of the rotary knob 53 relative to the handle 61. It should be noted that, the number of the key teeth 841 may be changed.

The second resilient member 85 is disposed for biasing the operating block 83 to engage the selected keyways 812.

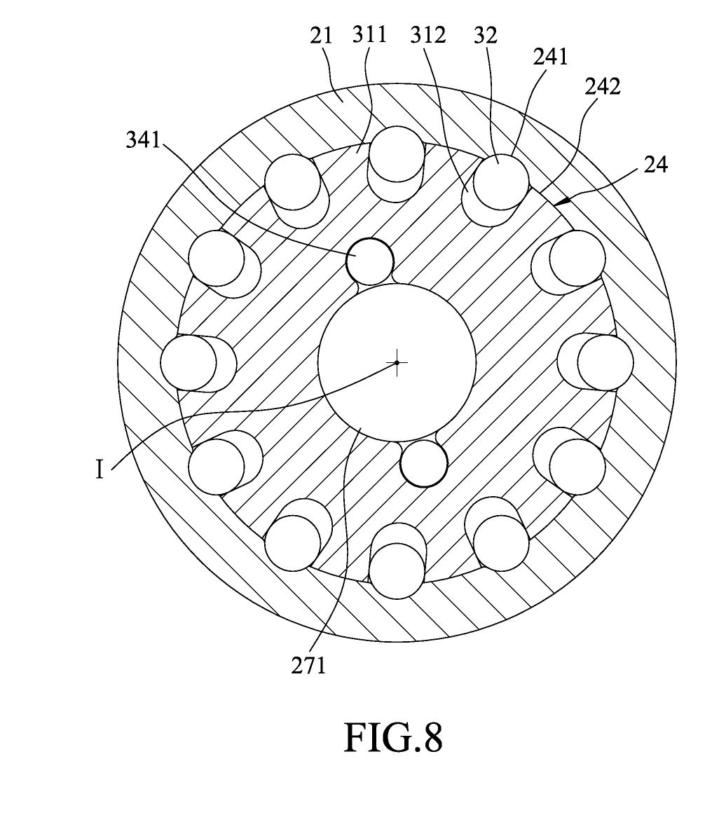

With particular reference to FIGS. 7 and 8, since the first resilient member 40 is disposed between the pushing block 33 and the pressing block 51, the pushing block 33 is biased toward the supporting member 31. As such, the braking members 32 are confined between the frustoconical surface 333 of the pushing block 33 and a wall of the supporting member 31 defining the accommodating grooves 312, so that the frustoconical surface 333 applies a radial pushing force to move the braking members 32 toward the internal toothed ring 24, thereby providing resistance to rotation of the tool head 21 relative to the handle 61.

During use, when an axial pushing force applied by the first resilient member 40 to the pushing block 33 is greater than a coupling force applied to the fastener 100, the tool head 21 can rotate the fastener 100.

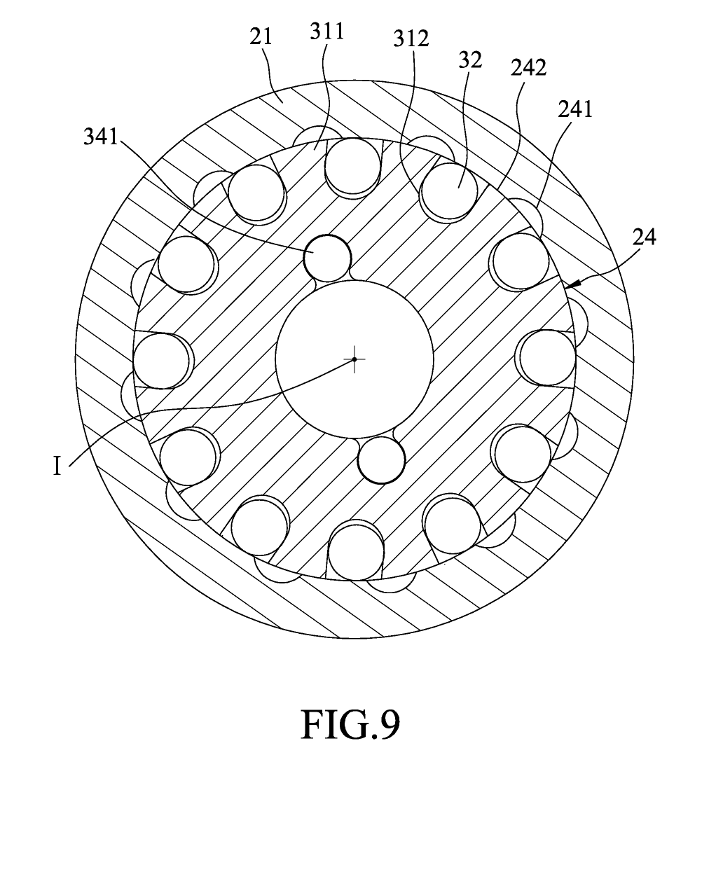

With particular to FIGS. 7 and 9, when the axial pushing force applied by the first resilient member 40 to the pushing block 33 is smaller than the coupling force applied to the fastener 100, the tool head 21 cannot rotate the fastener 100, thereby resulting in an idle rotation of the tool head 21. At this time, there is a need to increase the torque applied to the fastener 100.

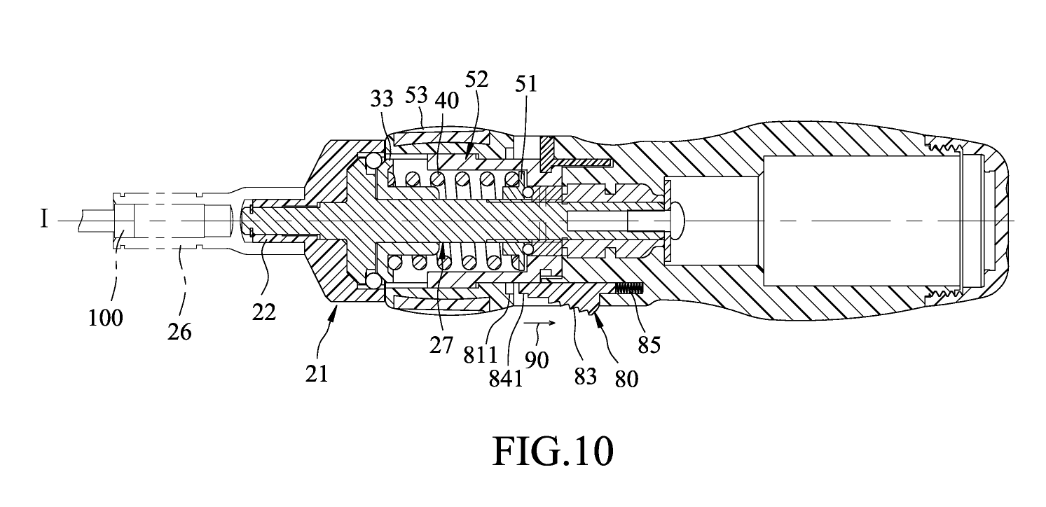

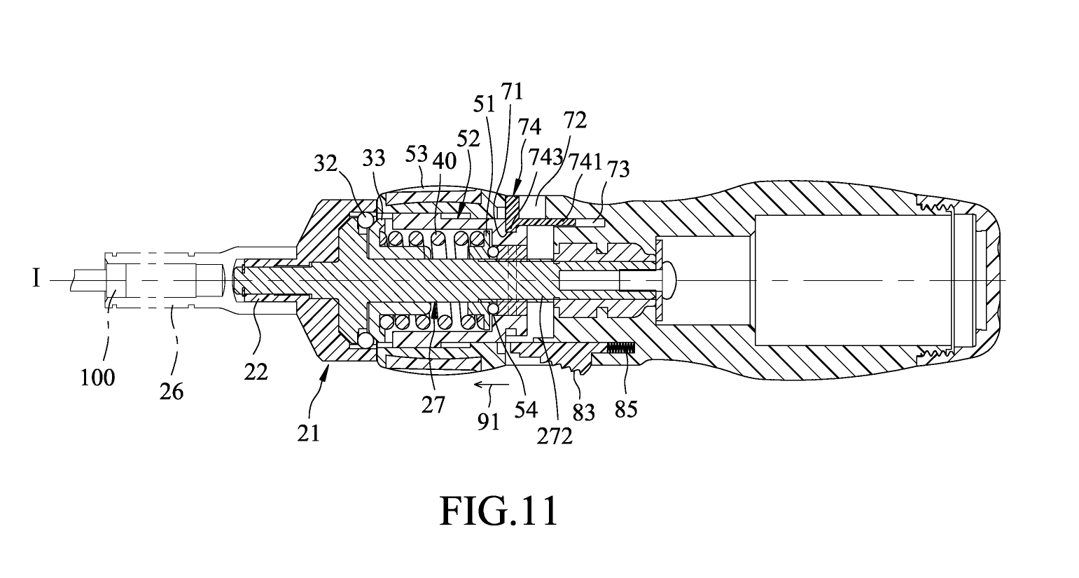

With particular reference to FIGS. 7 and 10, when it is desired to increase the torque applied to the fastener 100, the operating block 83 is removed from the rotary knob 53 in a rearward direction 90 to release the rotary knob 53, as shown in FIGS. 10 and 11. Next, the rotary knob 53 is rotated in a direction such that the adjusting member 52 is moved toward the tool head 21 in a direction 91 (see FIG. 11) to move the pressing block 51 toward the pushing block 33 through the connecting mechanism 54, thereby increasing the compressed amount of the first resilient member 40, the axial pushing force applied by the first resilient member 40 to the pushing block 33, the radial braking force applied by the braking members 32 to the tool head 21, and the output torque of the tool head 21.

Since the connecting projection 743 of the indicating member 74 is engaged within the annular groove 71, and since the annular groove 71 is formed in the adjusting member 52, when the rotary knob 53 is rotated, the adjusting member 52 moves along the axis (I) due to engagement between the nut 522 and the threaded section 272 of the central shaft 271. At the same time, the indicating member 74 moves synchronously with the adjusting member 52. Consequently, the revolution number of the adjusting member 74 can be realized from relative position between the pointer 744 and the revolution number scale 75, and the torque value of the tool head 21 can be realized from relative position between the pointer 744 and the torque scale 76. Upon completion of the torque adjustment, the operating block 83 is released to allow the operating block 83 is biased by the second resilient member 85 to move forwardly to thereby engage the key teeth 841 of the toothed front end 84 with three of the keyways 812 in the rotary knob 53, so that the rotary knob 53 is locked relative to the handle 61.

It should be noted that, the braking unit 30 and the internal toothed ring 24 may be omitted. If this occurs, the first resilient member 40 is disposed between the tool head 21 and the pressing block 51 to bias the tool head 21 and the pressing block 51 away from each other, so that an axial pushing force is directly applied to the tool head 21 by the first resilient member 40. In this case, when the rotary knob 53 is rotated to move the adjusting member 52 along the axis (I), the first resilient member 40 is compressed by the pressing block 51 and the tool head 21 to adjust the axial pushing force, and the indicating member 74 moves synchronously with the adjusting member 52 so that the pointer 744 cooperates with the revolution number scale 75 to indicate the revolution number of the adjusting member 52.

In view of the above, the hand tool of this invention has the following advantages:
1. When the rotary knob 53 is rotated to adjust the torque of the tool head 21, the adjusting member 52 can move the indicating member 74 in the slide slot 72 so that, through cooperation of the pointer 744 and the revolution number scale 75, the revolution number of the adjusting member 52 can be realized, and through cooperation of the pointer 744 and the torque scale 76, the output torque of the tool head 21 can be realized. Furthermore, since the output torque of the tool head 21 is proportional to the revolution number of the adjusting member 52, the output torque of the tool head 21 also can be realized from the revolution number scale 75. As a result, the hand tool is convenient to use.
2. Since the rotary knob 53 can be locked relative to the handle 61 by the locking unit 80, a desired torque output of the tool head 21 can be maintained effectively.
3. Due to the presence of the connecting mechanism 54, the adjusting member 52 can rotate smoothly, and friction between the pressing block 51 and the adjusting member 52 can be reduced. The rotary knob 53 is easy to operate accordingly.
4. Also due to the presence of the connecting mechanism 54, rotation of the pushing block 33 can be prevented, so that the braking members 32 can press stably against the pushing block 33, thereby increasing the torque adjustment precision.

With this invention thus explained, it is apparent that numerous modifications and variations can be made without departing from the scope and spirit of this invention. It is therefore intended that this invention be limited only as indicated by the appended claims.

I claim:

1. A hand tool comprising:
a main shaft unit including a central shaft extending along an axis and having a front end and a threaded section, and a tool head sleeved rotatably on said front end of said central shaft;
an adjustment unit including a pressing block sleeved movably on said central shaft, an adjusting member threaded to said threaded section of said central shaft and rotatable to move said pressing block on said central shaft, and a rotary knob sleeved on and co-rotatable with said adjusting member and allowing for manual operation;
a first resilient member sleeved on said central shaft between said pressing block and said tool head for biasing said pressing block and said tool head away from each other;
a handle unit including a handle sleeved fixedly on said central shaft and adjacent to said rotary knob; and
an indication unit including a slide slot formed in said handle, an indicating member disposed movably on said handle and having a guiding projection movable within said slide slot along a direction parallel to said axis, and a revolution number scale disposed on said handle and adjacent to said slide slot, said indicating member being connected to and co-movable with said adjusting member.

2. The hand tool as claimed in claim 1, wherein said indication unit further includes an insert groove formed in said handle, said indicating member having an insert plate portion inserted movably into said insert groove in said handle, an annular groove formed in said adjusting member, and a connecting projection extending from a side surface of said insert plate portion and engaging movably said annular groove in said adjusting member, said guiding projection extending from an opposite side surface of said insert plate portion and being formed with a pointer.

3. The hand tool as claimed in claim 2, wherein said indication unit further includes a torque scale disposed on said rotary knob and adjacent to said annular groove in said adjusting member.

4. The hand tool as claimed in claim 1, further comprising a locking unit that includes:
a plurality of angularly equidistant teeth formed on said rotary knob and defining a plurality of keyways each disposed between two adjacent ones of said teeth;
a block-receiving slot formed in said handle and extending along a direction parallel to said axis; and
an operating block inserted movably into said block-receiving slot and having at least one key tooth engaging removably a selected one of said keyways so as to prevent rotation of rotary knob relative to said handle, said operating block being movable manually within said block-receiving slot to remove said key tooth from said selected one of said keyways so as to allow for rotation of said rotary knob relative to said handle.

5. The hand tool as claimed in claim 4, wherein said locking unit further includes a second resilient member disposed in said handle for biasing said key tooth to engage said selected one of said keyways.

6. The hand tool as claimed in claim 5, wherein said adjusting member includes a connecting wall, a nut fixed within said connecting wall and engaging said threaded section of said central shaft, said adjusting unit further including a connecting mechanism that includes a first annular groove formed in said pressing block, a second annular groove formed in said nut, and a plurality of balls each engaging said first and second annular grooves.

7. The hand tool as claimed in claim 6, wherein said adjusting member has a splined outer surface, and said rotary knob has a splined inner surface that engages said splined outer surface so as to allow for movement of said adjusting member relative to said rotary knob, while preventing rotation of said adjusting member relative to said rotary knob.

8. The hand tool as claimed in claim 7, wherein said handle unit further includes a locking block fixed within said handle, a polygonal hole formed in said locking block, and a lock bolt that locks said central shaft relative to said locking block.

9. The hand tool as claimed in claim 6, wherein said tool head further includes an internal toothed ring, said hand tool further comprising a braking unit, said braking unit including a supporting member disposed fixedly on said central shaft and adjacent to said internal toothed ring, a plurality of braking members, and a pushing block, said supporting member having a plurality of accommodating grooves that receive respectively said braking members, said braking members being confined among said internal toothed ring, said supporting member, and said pushing block, said first resilient member being confined between said pushing block and said pressing block.

10. The hand tool as claimed in claim 9, wherein said braking unit further includes an anti-rotation mechanism that includes a stub extending from one of said supporting member and said pushing block, and a groove formed in the other of said supporting member and said pushing block and engaging said stub, so as to prevent relative rotation between said supporting member and said pushing block.
